(19) United States
(12) Patent Application Publication
(10) Pub. No.: US 2015/0324924 A1
(43) Pub. Date: Nov. 12, 2015

(54) Streamlined Claims Processing

(71) Applicant: Allstate Insurance Company, Northbrook, IL (US)

(72) Inventors: Thomas Joseph Wilson, Chicago, IL (US); Stephen Lawrence Ihm, Kildeer, IL (US); Randall Martin Hanson, Grayslake, IL (US)

(21) Appl. No.: 14/465,475

(22) Filed: Aug. 21, 2014

Related U.S. Application Data
(63) Continuation-in-part of application No. 13/458,388, filed on Apr. 27, 2012.
(60) Provisional application No. 62/014,942, filed on Jun. 20, 2014.
(60) Provisional application No. 61/480,207, filed on Apr. 28, 2011.

(51) Int. Cl. G06Q 40/08

(52) U.S. Cl. CPC G06Q 40/08

(57) ABSTRACT

An enhanced claims settlement apparatus may process insurance claims rapidly and accurately. The apparatus may first receive a notification of loss associated with an insured item (e.g., car, boat, truck, home, etc.). The apparatus may then apply various algorithms for using sensors to identify, analyze, and estimate the cost of damage associated with the insured item. The sensors that are a part of the enhanced claims settlement server may include cameras, tactile sensors, electromagnetic sensors, etc. that may communicate data to a processor associated with the server. Once the data has been generated and analyzed by the sensors, a claim settlement file may be transmitted to a claimant.

### CROSS-REFERENCE TO RELATED APPLICATIONS

The present application is a continuation-in-part (CIP) of U.S. application Ser. No. 13/458,388 entitled “Enhanced Claims Settlement” and filed on Apr. 27, 2012, which claims the benefit of U.S. Provisional Application No. 61/480,207 entitled “Enhanced Claims Settlement” and filed on Apr. 28, 2011, each of which are incorporated by reference herein their entirety.

The present application also claims the benefit of U.S. Provisional Patent Application No. 62/014,942 entitled “Streamlined Claims Processing” and filed on Jun. 20, 2014 which is also incorporated by reference herein in its entirety.

### BACKGROUND

Handling insurance claims can be a time-consuming and complex process for both the claimant and the claims processor. The claimant often starts the process with a first notice of loss to a claims processing office associated with an insurance company. Usually, a claims adjuster within the claims processing office is assigned to the case to assess the damage for which compensation is sought.

The claims adjustment process can involve paperwork processing, telephone calls, and potentially face-to-face meetings between claimant and adjuster. In addition, time can elapse between a first notice of loss from the claimant and the final settlement of the claim.

### BRIEF SUMMARY

The following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the disclosure involve a streamlined and efficient process for claims management and disclose methods, computer readable media, and apparatuses for processing and settling claims related to an insured item quickly and accurately. An enhanced claims settlement server may manage the settlement process from initial notification of loss to final settlement of the claim with a claimant.

In another aspect of the disclosure, an enhanced claims settlement server may communicate with a variety of sensors for assessing damage to insured items.

In another aspect of the disclosure, an enhanced claims settlement server may generate a work order for transmission directly to a repair facility or a customer associated with a damaged item. The work order may include a non-negotiable payment amount for fixing damage to a damaged item.

In some aspects, an enhanced claims settlement server may base a payment amount listed in a work order on an analysis of the cost to repair prior, similar cases of damage to insured items. The enhanced claims settlement server may also base the payment amount on telematics data and loss fact information.

In other aspects, an enhanced claims settlement server may implement a feedback loop to more accurately predict the cost of repair to a damaged item. In this feedback loop, a repair facility may provide information related to an actual cost of repairing a damaged item. Upon receiving and analyzing this information, an enhanced claims settlement server may generate a more accurate payment amount in future cases involving similar damage to similar insured items.

Further aspects of the disclosure may be provided in a computer-readable medium having computer-executable instructions that, when executed, cause a computer, user terminal, or other apparatus to at least perform one or more of the processes described herein.

Additional aspects of the disclosure may relate to an apparatus comprising: a processor; and a memory configured to store computer readable instructions that, when executed by the processor, cause the processor to perform a method comprising: receiving a notification of an insurance claim associated with an item; using a plurality of sensors, analyzing and estimating a cost of damage associated with the item; based on the analysis and the estimate, generating a claim settlement file that includes the estimate of the cost of damage associated with the item, a list of vendors for repairing the item; and a payment to the claimant for the insurance claim.

Moreover, additional aspects of the disclosure relate to a method comprising: receiving, from a user device operated by a claimant, a notification of an insurance claim associated with an item; using a plurality of sensors associated with a processor of an enhanced claims settlement server, analyzing and estimating a cost of damage associated with the item; based on the analysis and the estimate, using the processor, generating a claim settlement file that includes the estimate of the cost of damage associated with the item, a list of vendors for repairing the item; and a payment for compensating the claimant for the insurance claim.

### BRIEF DESCRIPTION OF THE DRAWINGS

The present disclosure is illustrated by way of example and is not limited in the accompanying figures in which like reference numerals indicate similar elements and in which:

FIG. 1 shows an illustrative operating environment in which various aspects of the disclosure may be implemented.

FIG. 2 shows a block diagram of workstations and servers that may be used to implement the processes and functions of certain aspects of the present disclosure.

FIG. 3 shows a diagram of a first process flow using an enhanced claims settlement server in accordance with at least one aspect of the present disclosure.

FIG. 4 illustrates an enhanced claims settlement apparatus in accordance with at least one aspect of the present disclosure.

FIG. 5 illustrates a second process flow using an enhanced claims settlement server in accordance with at least one aspect of the present disclosure.

FIG. 6 illustrates a process for generating a work order for use in repairing damage to a damaged item in accordance with at least one aspect of the present disclosure.

### DETAILED DESCRIPTION

In accordance with various aspects of the disclosure, methods, computer-readable media, and apparatuses are disclosed in which insurance claims may be settled through an enhanced automated process. In certain aspects, an enhanced claims settlement server manages the claims settlement process from an initial notice of loss to transmittal of an appropriate payment for the claim.

The automated process may utilize various hardware components (e.g., processors, communication servers, memory devices, sensors, etc.) and related computer algorithms to examine an insured item after a claim has been filed for that item and to generate a settlement file that may include information regarding an estimate of the damage caused to the item, approved vendors and available times for repairing and/or replacing the item, and a payment and/or wire transfer to a claimant or vendor for the loss.

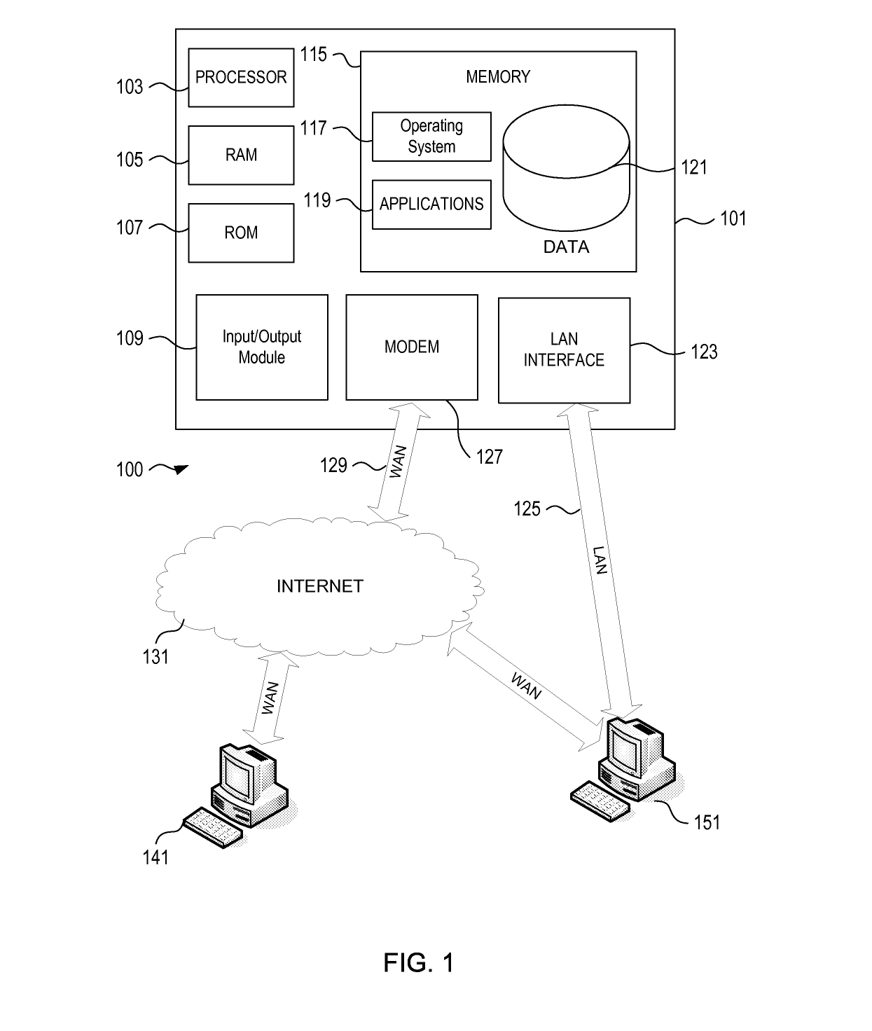

FIG. 1 illustrates a block diagram of an enhanced claims settlement server 101 in communication system 100 that may be used according to an illustrative embodiment of the disclosure. Enhanced claims settlement server 101 may have a processor 103 for controlling overall operation of the enhanced claims settlement server 101 and its associated components, including RAM 105, ROM 107, input/output module 109, and memory 115.

Input/output module 109 may include a microphone, keypad, touch screen, and/or stylus through which a user of enhanced claims settlement server 101 may provide input, and may also include one or more of a speaker for providing audio output and a video display device for providing textual, audiovisual and/or graphical output. Software may be stored within memory 115 to provide instructions to processor 103 for enabling enhanced claims settlement server 101 to perform various functions. For example, memory 115 may store software used by the enhanced claims settlement server 101, such as an operating system 117, application programs 119, and an associated database 121. Processor 103 and its associated components may allow the enhanced claims settlement server 101 to run a series of computer-readable instructions to determine an estimate of loss suffered by a claimant and generate the appropriate payment for the loss. In addition, processor 103 may determine an approved list of vendors for replacing and/or repairing an item that relates to a claim. Processor 103 may also schedule and accept appointments with vendors that may aid in repairing/replacing the item.

The enhanced claims settlement server 101 may operate in a networked environment supporting connections to one or more remote computers, such as terminals 141 and 151. The terminals 141 and 151 may be personal computers or servers that include many or all of the elements described above relative to the enhanced claims settlement server 101. Also, terminal 141 and/or 151 may be sensors such as cameras and other detectors that allow damage related to an insured item for which a claim has been filed to be assessed. The network connections depicted in FIG. 1 include a local area network (LAN) 125 and a wide area network (WAN) 129, but may also include other networks. When used in a LAN networking environment, the enhanced claims settlement server 101 is connected to the LAN 125 through a network interface or adapter 123. When used in a WAN networking environment, the enhanced claims settlement server 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Additionally, an application program 119 used by the enhanced claims settlement server 101 according to an illustrative embodiment of the disclosure may include computer executable instructions for invoking functionality related to settling an insurance claim quickly and accurately (e.g., seconds or minutes). In one embodiment, the entire claim settlement process discussed herein may occur in ten minutes or less.

Enhanced claims settlement server 101 and/or terminals 141 or 151 may also be mobile and/or portable terminals including various other components, such as a battery, speaker, and antennas (not shown). In this regard, enhanced claims settlement server 101 may be a handheld or otherwise portable device that may be used to scan and process an insured item from all relevant angles.

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, programmable consumer electronics, network PCs, minicomputers, mainframe computers, and distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including non-transitory memory storage devices, such as a hard disk, random access memory (RAM), and read only memory (ROM).

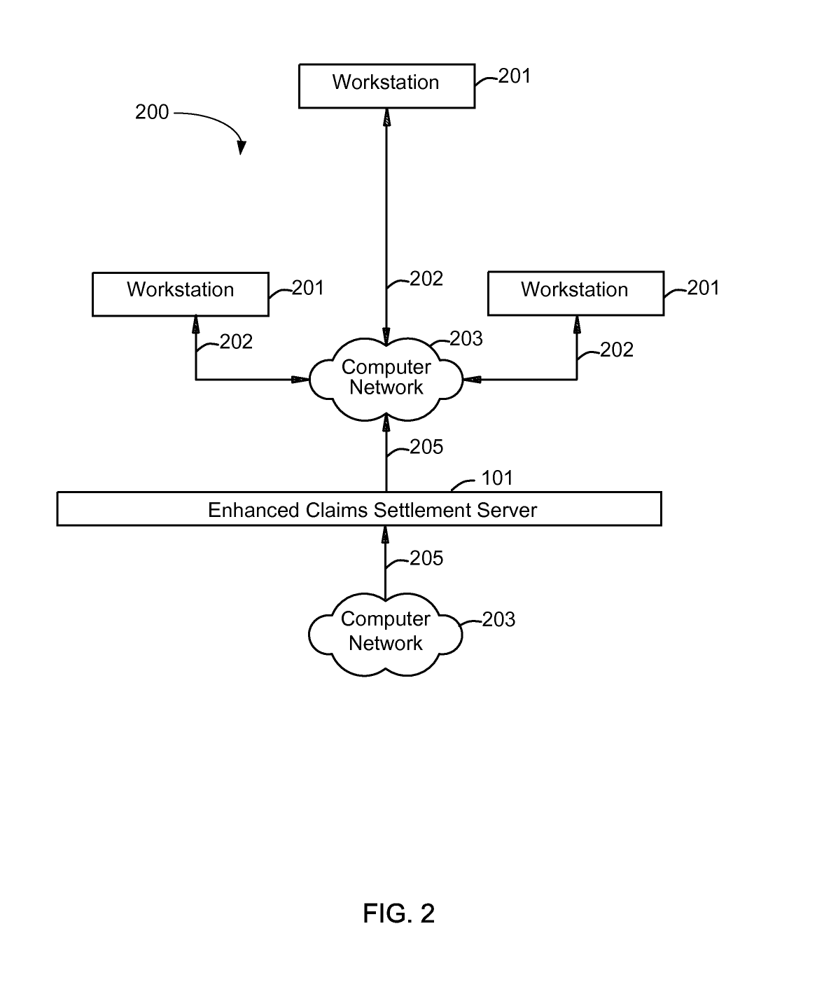

Referring to FIG. 2, a system 200 for implementing methods according to the present disclosure is shown. As illustrated, system 200 may include one or more workstations/servers 201. Workstations 201 may be local or remote, and are connected by one or more communications links 202 to computer network 203 that is linked via communications links 205 to enhanced claims settlement server 101. In certain embodiments, workstations 201 may run different algorithms used by enhanced claims settlement server 101 for settling a claim submitted by a claimant, or, in other embodiments, workstations 201 may be different types of sensors that provide information to enhanced claims settlement server 101 for assessing damage to an insured item for which a claim has been filed. In system 200, enhanced claims settlement server 101 may be any suitable server, processor, computer, or data processing device, or combination of the same.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and enhanced claims settlement server 101, such as network links, dial-up links, wireless links, hard-wired links, etc.

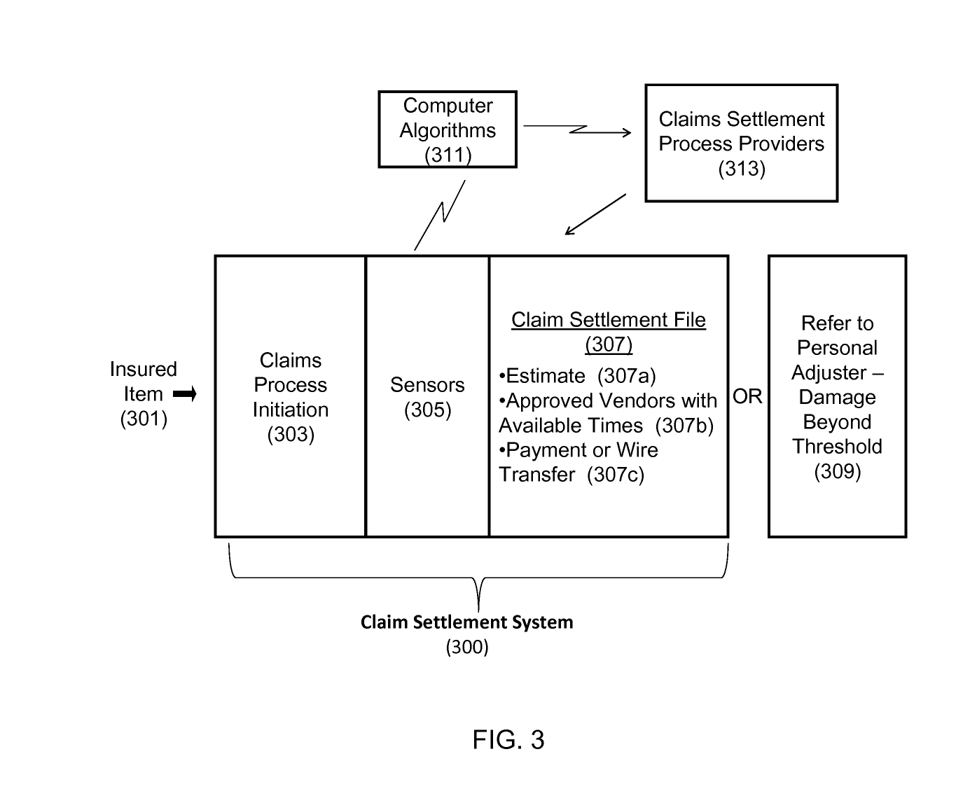

FIG. 3 shows a diagram of a first process flow 300 using an enhanced claims settlement server 101 in accordance with at least one aspect of the present disclosure. The process 300 may start out with a first notification of loss associated with an insured item 301 to enhanced claims settlement server 101. The notification may be an automated notification of an accident from a telematics device, smart phone, and/or other device to enhanced claims settlement server 101. In certain embodiments, if the accident is associated with a vehicle (e.g., car, truck, boat, etc.) the telematics device and/or smart phone may include an impact sensor that automatically transmits a notification of the accident involving the vehicle to enhanced claims settlement server 101 when certain impact parameters are detected. Additional information such as speed, braking or acceleration for the time period immediately preceding and immediately subsequent to the accident as well as vehicle identifying information or insured information also may be transmitted by the telematics device and/or smart phone to the enhanced claims settlement server 101. The vehicle identifying information may include license plate number, vehicle identification number, and/or vehicle make/model.

In other embodiments, the claim settlement process 300 may be initiated 303 by the swipe of an insurance card or card including identification information (such as a credit card) through a sensor or card reader 305 of enhanced claims settlement server 101. The insurance card or other card including identification information may include information related to the identity of the claimant (e.g., name, date of birth, terms of active insurance policies, etc.). In other embodiments, the claim settlement process 300 may be initiated by driving to a predetermined location associated with server 101 and having a license plate and/or vehicle identification number (VIN) read by a processor 103 (e.g., when the insured item 301 is a vehicle).

In certain aspects, the claim settlement process 300 may use one or more sensors 305 that are a part of or in communication with enhanced claims settlement server 101 to assess damage associated with insured item 301. The sensors 305 may function simultaneously or sequentially (e.g., insured item 301 may be moved from one sensor station to another) to gather data about damage related to item 301.

The sensors 305 that are a part of enhanced claims settlement server 101 may include various types of cameras (e.g., movable cameras, etc.) for taking optical digital images and/or other computing/mechanical devices 201 that may make laser and/or tactile measurements (e.g., for understanding the depth of damage to insured item 301). The sensors 305 may also measure the interaction of pressure (e.g., sound) waves or X-rays on the insured item 301 to analyze damage to the insured item 301. In yet other embodiments, various types of imaging technologies may be used to analyze the insured item 301. For instance, magnetic resonance imaging (MRI), infrared imaging, 3-d imaging technologies (e.g., holographic imaging, etc.), and/or various types of tomography may be used to image insured item 301. The sensors 305 may also sense fluids such as transmission fluids, brake fluids, engine oil, etc. leaking from insured item 301. In other embodiments, sensors 305 may sense various aspects of tires that are a part of insured item 301 (e.g., when insured item 301 is a vehicle). For instance, sensors 305 may indicate that a frame associated with a body or a rim associated with a tire of insured item 301 is bent. Using sensors 305, server 101 may create a digital map showing the damage to insured item 301.

When the insured item 301 is a vehicle, enhanced claims settlement server 101 may also dock with an on-board diagnostic (OBD) or OBD-II system that may be a part of the vehicle's electronics system. The information recorded by the OBD and/or OBD-II system may include coolant temperature, engine RPM, vehicle speed, timing advance, throttle position, and the oxygen sensor, among other things. The OBD/OBD-II system or other system may also be used by enhanced claims settlement server 101 to check the mileage in a vehicle for underwriting and/or pricing purposes. All of this information may be used by enhanced claims settlement server 101 to evaluate any damage to insured item 301.

In addition to gathering information through various sensors, enhanced claims settlement server 101 may also include a computer interface for a claimant to input information and/or answer questions (e.g., an automated questionnaire, etc.) around prior damage, liability, particulars of an accident, etc.

In certain aspects, enhanced claims settlement server 101 may be configured to detect fraudulent claims. For instance, the automated questionnaire discussed above may also ask about an accident associated with the claim. The answers to the questions regarding the accident may be compared to the actual damage or sensor or OBDII readings associated with insured item 301. If enhanced claims settlement server 101 determines that there are discrepancies between the actual damage or sensor or OBDII readings associated with insured item 301 as assessed by sensors 305 and a description of the damage provided in the answers to the automated questionnaire, then enhanced claims settlement server 101 may notify a claims adjuster (e.g., adjuster 309, discussed below) to intervene or take other action such as to terminate the claim. Also, if insured item 301 is a vehicle, server 101 may compare particulars about the vehicle (e.g., make, model, year of manufacture, VIN, etc.) to previously obtained vehicle information (e.g., stored in a memory associated with server 101 and/or on file with an entity managing server 101) for detecting fraud. Further, if after further analysis, the number of false positives for detecting fraud is beyond a predetermined threshold, the algorithm and/or questions used to detect fraud may be adjusted accordingly.

As another example, enhanced claims settlement server 101 may be able to determine the speed of the insured item 301 (e.g., a vehicle) when an accident occurs. The speed determined by enhanced claims settlement server 101 may be compared with the speed indicated by a claimant in the questionnaire. Finally, the enhanced claims settlement server 101 may also be able to determine the number of people and the positions of each individual in the insured item 301 (e.g., a vehicle) when an accident occurs. This information may also be compared with the corresponding descriptions indicated by a claimant in the questionnaire.

In other aspects, enhanced claims settlement server 101 may be able to interface with other databases/systems. For instance, server 101 may interface with meteorological databases to retrieve the weather conditions at the time of an accident associated with insured item 301. Server 101 may also interface with law enforcement databases to retrieve police reports of an accident associated with insured item 301 or with medical records or other databases related to people involved in an accident associated with the insured item 301.

Once the insured item 301 has been adequately analyzed by sensors 305, enhanced claims settlement server 101 may then generate a claim settlement file 307. In certain aspects, enhanced claims settlement server 101 may automatically generate claim settlement file 307. The claim settlement file 307 may include an estimate 307a of the damage to insured item 301, approved vendors 307b with available times for repairing and/or replacing insured item 301, a list of parts and part vendors for repairing the insured item 301, a list of replacements and replacement sources for the insured item 301 and various portions of insured item 301 where repair is not feasible, and a payment or wire transfer 307c by an entity (e.g., an insurance company) managing enhanced claims settlement server 101 to an insured of insured item 301 (e.g., the claimant) for the assessed damage associated with insured item 301, among other things. In addition to or alternatively, if the owner of insured item 301 is to be provided compensation for loss/damage to insured item 301, enhanced claims settlement server 101 may generate a payment card (e.g., a prepayment card) that may be used by the owner of insured item 301.

In another aspect of the disclosure, claim settlement file 307 may stipulate various terms of the settlement, including discounts provided to an owner of the insured item 301 for errors on the part of enhanced claims settlement server 101. For instance, the claims settlement file 307 may provide for a predetermined discount (e.g., 10% off) for any out-of-pocket expense associated with replacing/repairing the insured item 301 if the enhanced claims settlement server 101 does not detect all of the damage associated with insured item 301 (e.g., hidden damage) and/or if the estimate 307a of the damage to insured item 301 is not accurate (e.g., as determined by an adjustor or a third party vendor such as a repair shop). Moreover, once the claim settlement file 307 has been generated by enhanced claims settlement server 101, the information in file 307 may be transmitted to an owner of insured item 301.

In general, the claim settlement file 307 may resolve all the issues associated with settling a claim involving insured item 301. Alternatively and/or additionally, if the claim settlement file 307 does not resolve all the issues (e.g., damage cannot be assessed, disagreement between the claimant and the enhanced claims settlement server 101, etc.) or for verification or training associated with settling a claim involving insured item 301, the enhanced claims settlement server 101 may refer a claimant to a personal adjuster 309 for generating or verifying a finalized estimate of any damage.

The adjuster 309 may view the insured item 301 through a video feed and enhanced claims settlement server 101 may manipulate sensors 305 (e.g., cameras, etc.) to capture a desired view. For instance, the enhanced claims settlement server 101 may allow the adjuster to communicate via an electronic interface that instructs the server 101 to move sensors 305 to a given angle. Alternatively or in addition, insured item 301 may be directly manipulated by sensors 305 (e.g., mechanical arms, etc.) to allow adjustor 309 to examine a desired view of the insured item 301. For instance, the adjuster may instruct server 101 to move robotic arms or lifts that are able to position the insured item 301 so that the adjuster can view an appropriate portion of insured item 301.

As mentioned above, enhanced claims settlement server 101 may generate holograms (e.g., based on magnetic resonance imaging (MRI) or other techniques using predictive computer-aided design (CAD)-type technologies, etc.) for allowing adjusters and other individuals to view the insured item 301. The holograms may represent three-dimensional images of insured item 301 and may allow individuals to view the exterior of insured item 301 as well as features internal to insured item 301. For instance, a hologram may allow the different components comprising a vehicle's engine to be viewed and analyzed in ways that would not be feasible with traditional imaging modalities.

In some aspects, computer algorithms 311 which may be used in determining damage may be based on specifications and/or tolerances data related to a manufacturer of insured item 301. The computer algorithms 311, which may be stored in a memory 115 of enhanced claims settlement server 101, may also direct enhanced claims settlement server 101 to automatically delete any photos non-relevant to damage of/data related to insured item 301 based on a comparison of the photos/data to manufacturer specifications/tolerances. Once the data/photos related to insured item 301 are generated by various sensors 305 and/or once the claim settlement file 307 is generated by enhanced claims settlement server 101, the enhanced claims settlement server 101 may allow access of the file 307 and/or data/photos to an individual/group associated with insured item 301 (e.g., the claimant, etc.). In some embodiments, claim settlement process providers 313 may receive the payment 307c so that they may transmit the payment 307c to either the claimant, vendor, or a third party vendor (e.g., for repairing/replacing insured item 301).

In other aspects, enhanced claims settlement server 101 may automatically apply a deductible amount to any claim settlement file 307 generated through process 300. In addition, enhanced claims settlement server 101 may also automatically generate cross-sell material (e.g., other products/services offered by the entity managing enhanced claims settlement server 101) for review while a claimant waits for a claim settlement file 307 to be generated. For instance, if the entity managing enhanced claims settlement server 101 is an insurance company, the enhanced claims settlement server 101 may generate information about other types of insurance products offered by the insurance company while the claimant is waiting for the claim settlement.

In certain aspects, the entire process 300 may be highly automated and, therefore, completed in a short amount of time (e.g., seconds, minutes, etc.).

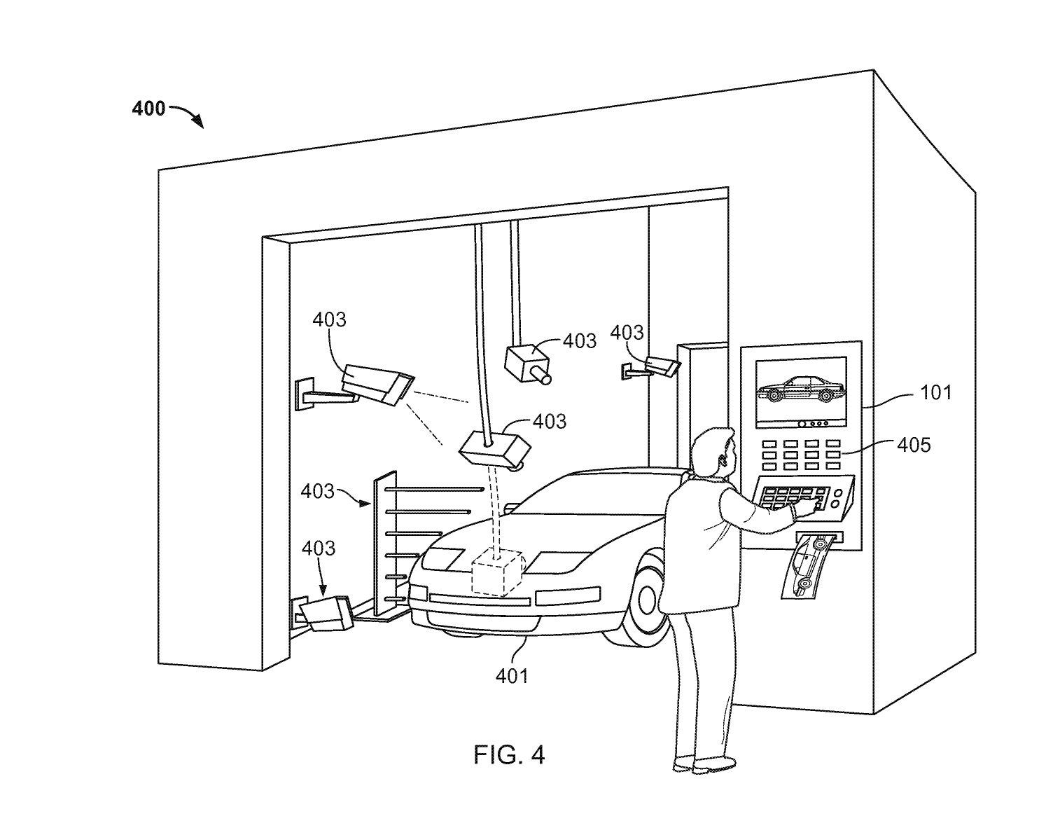

FIG. 4 illustrates an enhanced claims settlement apparatus 400 employing an enhanced claims settlement server 101 in accordance with various aspects of the present disclosure. FIG. 4 shows an example of how the enhanced claims settlement server 101 may be used when the insured item 301 is a vehicle 401. In FIG. 4, an owner of vehicle 401 may file a claim for damage to vehicle 401. The owner may notify enhanced claims settlement server 101 through any of the various modalities mentioned above, including automatic notification via a telematics device, through manual notification, and/or by simply driving to a predetermined location associated with server 101. Vehicle 401 may be analyzed by various sensors 403 (e.g., cameras, tactile sensors, ultrasonic sensors, electromagnetic sensors, etc.), which may be a part of enhanced claims settlement apparatus 400, to determine damage caused to vehicle 401 so that a claim settlement file 307 may be generated by enhanced claims settlement server 101. Enhanced claims settlement server 101 may also include a user interface 405 through which a user may perform various activities. For instance, a user may swipe an insurance card associated with vehicle 401 through user interface 405. In addition, a user may, through user interface 405, view/print photos, data, and other information generated by enhanced claims settlement server 101.

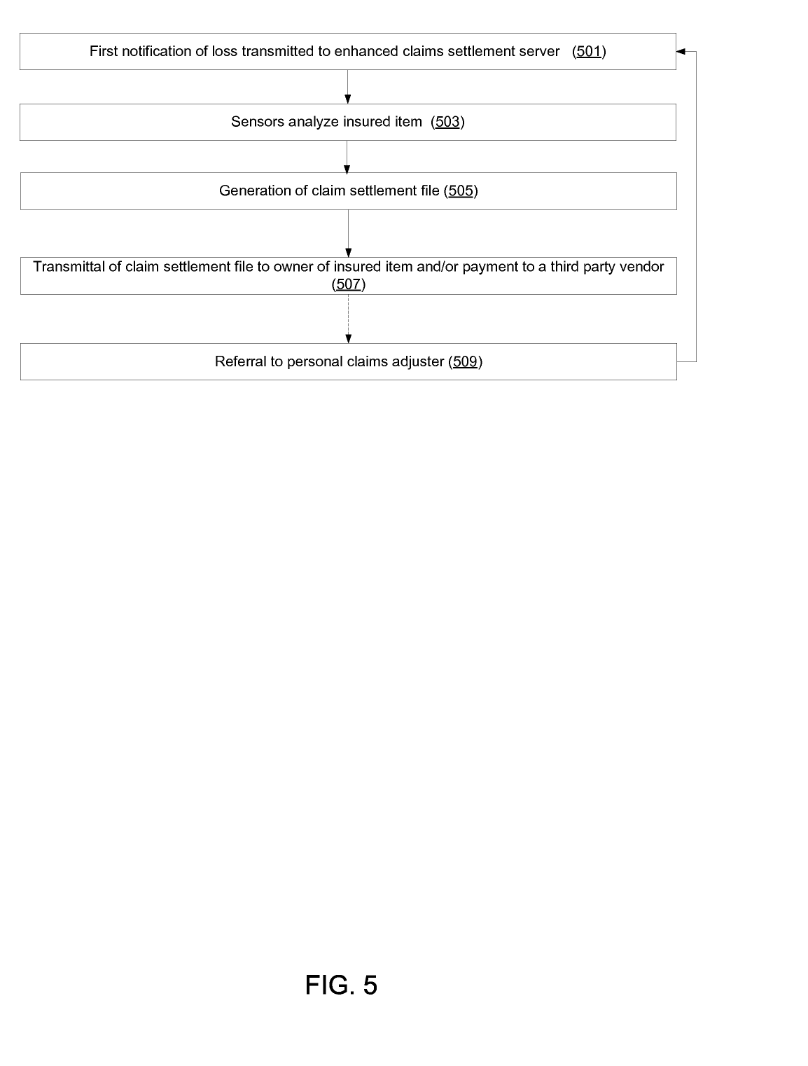

FIG. 5 illustrates a second process flow using an enhanced claims settlement server 101 in accordance with at least one aspect of the present disclosure. The process of FIG. 5 may start out at step 501 where a first notification of loss may be transmitted to an enhanced claims settlement server 101. As mentioned earlier, this notification may occur in various ways; for instance, either an automatic or a manual notification may be transmitted from a communication device operated by an owner/operator of an insured item 301 (e.g., the claimant) and/or the insured item 301 (e.g., a vehicle) may be driven to a predetermined location associated with server 101. Alternatively or in addition, the first notification of loss may occur through the swipe of an insurance card or other id card through a sensor 305 (e.g., a card reader) associated with enhanced claims settlement server 101. After this initial notification, the process may move to step 503 where sensors 305 may analyze damage related to insured item 301. For instance, as shown in FIG. 4, if the insured item 301 is a vehicle 401, the enhanced claims settlement server 101 may house and/or be in communication with a number of sensors 403 (e.g., cameras, electromagnetic sensors, ultrasound sensors, etc.) that generate photos, data, and other information about the damage associated with the vehicle 401.

These photos and data may be analyzed through various algorithms stored as computer-executable instructions on enhanced claims settlement server 101. Enhanced claims settlement server 101 may store predefined rules for determining key areas of insured item 301 to analyze and/or image. For instance, if the insured item 301 is a vehicle 401, the enhanced claims settlement server 101 may use object recognition algorithms and/or imaging software to determine the make/model of the vehicle 401 and to compare photos of portions of a damaged vehicle 401 with photos of similar portions of an undamaged vehicle, such as photos obtained from a manufacturer's specification. The object recognition algorithms and/or imaging software may track one or many multiple specific points of a portion of the vehicle to determine which portions may be damaged. For instance, to determine if a door has actually been damaged, the algorithms and/or software may track the center of a door to determine if the center is at an appropriate distance from an edge of the door. This analysis may also be used to determine the extent or level of damage to the car door (e.g., repair versus replace). As another example, the enhanced claims settlement server may use infrared imaging technology to image the temperature of various components within a vehicle's engine. By cross-referencing the temperature profile with the heat tolerances set by the manufacturer, enhanced claims settlement server 101 may determine that the vehicle 401 may need certain engine components replaced (e.g., a new timing belt, muffler, etc.). As yet another example, tactile sensors that contact the contour of a vehicle 401 may determine that certain body parts associated with the vehicle 401 have dents and/or scratches that require repair.

In other aspects, the object recognition algorithms and/or imaging software used to determine the make/model of the vehicle may be defined by manufacturer or after-market specifications and appropriate tolerances. For instance, a manufacturer specification may define the exact dimensions of a car door and/or an engine part. Because each manufacturer specification may have different definitions and tolerances, enhanced claims settlement server 101 may be able to retrieve the appropriate specification based on predefined criteria.

In analyzing the damage to the insured item 301, the enhanced claims settlement server 101 may also determine the level of a particular damage. For example, the enhanced claims settlement server 101 may determine whether the damage to the item 301 is small enough to be repaired or large enough to require replacement of the item 301 and/or a part of the item 301.

After sensors 305 gather and analyze data associated with insured item 301, the process of FIG. 5 may then move to step 505 where enhanced claims settlement server 101 may generate a claims settlement file 307. The claims settlement file 307 may be generated by determining the extent of the damage to insured item 301 and then cross-referencing pricing information accessible to enhanced claims settlement server 101. For instance, in the example of damage associated with a vehicle 401, enhanced claims settlement server 101 may access pricing information for replacing the vehicle 401 or a part of vehicle 401 and/or for repairing the damage to vehicle 401 stored in internal databases associated with enhanced claims settlement server 101. In addition, enhanced claims settlement server 101 may access this information in remotely stored databases and/or through pricing information from vendors found on the Internet. The analysis of the data generated from sensors 305 and the pricing information cross-referenced from this analysis may form the basis for the claim settlement file 307 generated in step 505.

As mentioned earlier, the claim settlement file 307 may include a cost estimate 307a for replacing/repairing insured item 301, a list of vendors 307b that will repair/replace insured item 301 with their contact information (phone number, address, etc.) and the hours of availability, and a payment or wire transfer 307c that may serve as compensation for the loss suffered by the owner of insured item 301, among other things. The enhanced claims settlement server 101 may generate the list of vendors and associated information by accessing information stored in internal/remote databases (e.g., accessing the web pages of the vendors). To determine the vendors that are most convenient for a particular claimant, the enhanced claims settlement server 101 may include a global positioning system (GPS) that maps the closest distance of various vendors with the home/work address of the claimant.

The process of FIG. 5 may then move to step 507 where the information in the claim settlement file 307 generated in step 505 may be transmitted to the claimant. In some embodiments, the claimant may access the information in claim settlement file 307 through a user interface associated with enhanced claims settlement server 101, such as user interface 405. In other embodiments, the claimant may receive the information through an electronic device owned by the claimant (e.g., laptop, mobile phone, personal digital assistant (PDA), etc.). After the claimant receives the information in claim settlement file 307, the claimant may use the information for replacing and/or repairing the insured item 301. In particular, if the damage to insured item 301 is greater than a predetermined threshold, the claimant may use the information in claim settlement file 307 for finding a replacement for insured item 301 (e.g., a new car, etc.). In other embodiments, the payment 307c associated with a claim settlement file 307 may be transmitted directly to one of the approved vendors associated with replacing/repairing insured item 301. The claimant may then take insured item 301 to the vendor to have the item 301 repaired and/or replaced. In yet other embodiments, several different vendors may bid on how much repairing and/or replacing insured item 301 will cost. In this instance, enhanced claims settlement server 101 may transmit data related to the damage (e.g., photos, other sensor-generated data, etc.) to allow the vendors to generate a price quote. Once the enhanced claims settlement server 101 receives bids from all the vendors, the enhanced claims settlement server 101 may select the best (e.g., based on factors such as quality, location, and price) bid for repairing/replacing insured item 301.

If there are any unresolved issues in the claim settlement file and/or if the claimant has any unanswered questions, the process may optionally move to step 509 where the claimant may be referred to a personal claims adjuster. In other cases, a personal claims adjuster may receive the case if the damage to insured item 301 is beyond a predetermined threshold. In this embodiment, the claims settlement process discussed in FIG. 3 may never move forward; instead, the claims case may go directly to a personal claims adjuster.

In some embodiments, vendors/claimants may transmit feedback to enhanced claims settlement server 101 so that enhanced claims settlement server 101 may determine the accuracy of the estimate 307a for the cost of damage to insured item 301, as stated in the claim settlement file 307. In this case, the computer-executable program instructions stored on enhanced claims settlement server 101 may be updated as needed to create more accurate estimates. For instance, if the enhanced claims settlement server 101 repeatedly predicts that the cost of replacing a certain type of damage to a car door is $200 above what is being charged by vendors, the computer-executable program instructions stored on enhanced claims settlement server 101 may be updated (e.g., the algorithm may be changed) to reduce the estimate generated when sensors 305 detect this type of damage in the future. Further yet, if enhanced claims settlement server 101 predicts that damage to a vehicle is so severe that the vehicle needs to be replaced and feedback indicates that repair shops are able to fix the damage for a predetermined amount, the computer-executable program instructions stored on enhanced claims settlement server 101 may be similarly updated to correctly associate the types of damage with the vehicle to whether the vehicle needs to be replaced or repaired.

In other aspects, enhanced claims settlement server 101 may generate a work order for transmission directly to a repair facility or a customer associated with a damaged item (e.g., item 301). The work order may include a non-negotiable payment amount (e.g., a fixed price) for repairing the damage to the damaged item. In this way, the process of settling a claim may be streamlined to quickly repair damage to the damaged item.

For instance, a customer of an insurance company managing enhanced claims settlement server 101 may submit a claim for damage to the front bumper of his insured vehicle. Enhanced claims settlement server 101 may analyze prior cases of damage to the front bumper of similar vehicles along with telematics data related to the vehicle in question, if available. In particular, server 101 may access a database to determine one or more prior cases that involved vehicles of similar make and model that included similar damage to the front bumper. Server 101 may analyze the actual cost to repair damage to those vehicles and may use this information to determine a payment amount provided to a repair facility for repairing the damage to the front bumper of the vehicle in question. In addition, the telematics data may include data from various sensors associated with the vehicle, including sensors related to speed of the vehicle, acceleration/deceleration of the vehicle, and condition of the engine, among other things.

Server 101 may also analyze key loss fact information, such as information related to a first notice of loss (FNOL), speed of the vehicle when the damage to the front bumper occurred, location of vehicle when the damage occurred, the people involved in any accident that resulted in the damage to the vehicle, and whether or not the vehicle is drivable after the damage to the front bumper. In addition, as discussed previously, server 101 may use information from sensors 403 to determine the exact nature of the damage to the vehicle in question. This analysis may lead to a digital map of the damage to the vehicle in question.

All of this information may be used to provide a vehicle repair facility with a work order including a non-negotiable payment amount for repairing damage to the vehicle. For instance, enhanced claims settlement server 101 may determine that prior cases of similar damage to similar vehicles resulted in an average payment amount of $500. In addition, telematics data from the vehicle in question may indicate that the vehicle was moving at 25 miles per hour through a congested parking lot when the front bumper hit the side of another vehicle even though the brakes were applied quickly. Enhanced claims settlement server 101 may analyze all of this information to determine that the payment amount for a work order to repair the vehicle in question should be $450. This payment amount may be smaller than the average payment amount from prior similar cases for a variety of reasons. For instance, server 101 may have determined that the damage to the vehicle in question is less severe than the damage associated with the prior cases, or server 101 may have determined that the cost of repairing damage to the vehicle in question has gone down recently. In other embodiments, server 101 may determine that the payment amount for the work order is equal to or more than the average payment amount associated with prior, similar cases of damage.

The payment amount associated with the work order generated by enhanced claims settlement server 101 may be provided directly to a given repair shop or to a customer associated with the damaged item. In some embodiments, a customer may be given a code that may be used to identify himself to a given repair shop for work related to the work order to commence.

In some aspects, enhanced claims settlement server 101 may contact various repair shops in a predetermined location (e.g., close to a customer location, close to an analysis facility, etc.) to determine which repair shops will agree to the terms of the work order. Server 101 may present only those repair shops that agree to the terms of the work order to a customer associated with a damaged item.

In additional aspects, enhanced claims settlement server 101 may implement a feedback loop in the use of information from a repair shop. In this regard, after repairing a damaged item, a repair shop may provide an entity managing enhanced claims settlement server 101 (e.g., an insurance company) with an actual cost of repair. Server 101 may then use this information to more accurately generate payment amounts associated with work orders for repairing future damaged items.

In some aspects, enhanced claims settlement server 101 may quickly generate a work order for repairing a damaged item and may direct a customer associated with the damaged item to a predetermined repair shop. Server 101 may also provide (e.g., on a display associated with a user device of the customer, etc.) a list of participating repair shops within a predetermined distance of a customer location so that the customer may choose a repair shop from the list for repairing damage to a damaged item. In yet other embodiments, server 101 may also provide the payment amount associated with the work order to the customer so that the customer may use the payment amount at an acceptable repair shop. In further aspects, enhanced claims settlement server 101 may provide the customer with further information (e.g., hours of operation, services offered, etc.) about the repair shops that will accept the work order.

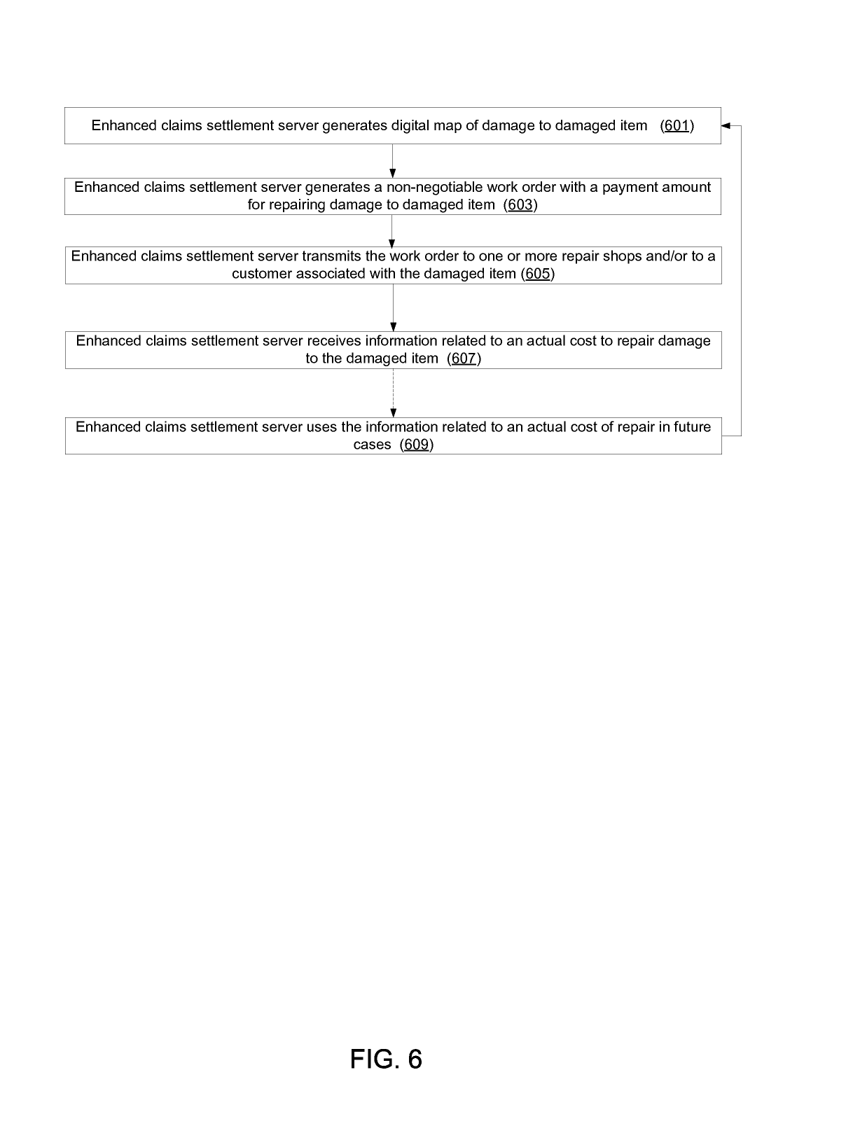

FIG. 6 illustrates a process for generating a work order for use in repairing damage to a damaged item in accordance with at least one aspect of the present disclosure. The process of FIG. 6 may start out at step 601 where enhanced claims settlement server 101 may create a digital map of damage to a damaged item. Enhanced claims settlement server 101 may create the digital map using a variety of sensors (e.g., sensors 403). These sensors may include cameras, tactile sensors, ultrasonic sensors, electromagnetic sensors, lasers, etc.

Once a digital map of the damage to the damaged item has been created, enhanced claims settlement server 101 may then generate a non-negotiable work order with a payment amount for repairing damage to a damaged item in step 603. To generate the work order, server 101 may use various types of information. For instance, if the damaged item is a vehicle, server 101 may use telematics data transmitted from a telematics device associated with the vehicle. Server 101 may also use information from a first notice of loss (FNOL) associated with the vehicle, information related to a location of an accident associated with the vehicle, and information about people involved in the accident associated with the vehicle to generate a payment amount associated with the work order. In addition, server 101 may use information from the actual cost of repair associated with prior, similar cases of damage to generate a payment amount associated with the work order.

Once the work order has been generated, the process may move to step 605 where enhanced claims settlement server 101 may transmit the work order to one or more repair shops and/or to a customer associated with the damaged item. In some embodiments, server 101 may transmit the work order to various repair shops located within a predetermined distance of a location of a customer associated with the damaged item. These repair shops may have already agreed to partner with an entity managing enhanced claims settlement server 101 (e.g., an insurance company) to provide repair services detailed in a work order provided by the entity managing enhanced claims settlement server 101. Alternatively, the repair shops that receive the work order may review the terms of the work order and then transmit information related to whether or not they agree to provide repair services under these terms. In either case, server 101 may provide information related to repair shops that will accept the terms of the work order to a customer associated with the damaged item so that the customer may have the damaged item repaired at one of these repair shops.

In alternative embodiments, enhanced claims settlement server 101 may provide the work order directly to the customer so that the customer may present the work order to a given repair shop. In additional embodiments, server 101 may provide the customer with an identification code that may be presented at a given repair shop. The identification code may allow the repair shop to identify the particulars of the customer and an associated work order to allow for efficient repair of the damaged item referenced in the work order.

Once information related to a work order has been transmitted to one or more repair shops and/or to an associated customer and the damaged item has been repaired, enhanced claims settlement server 101 may receive information related to an actual cost to repair damage to the damaged item in step 607. This information may be used by server 101 to generate a more accurate payment amount for future, similar cases in step 609.

One of ordinary skill in the art would recognize that the methods and systems discussed herein may be applied to all forms of insurance (e.g., home, auto, etc.) and financial services. For instance, the methods/systems of this disclosure (e.g., enhanced claims settlement server 101, handheld devices, etc.) may be used to process a homeowner's claim (e.g., for an insured home).

Aspects of the invention have been described in terms of illustrative embodiments thereof. Numerous other embodiments, modifications, and variations will occur to persons of ordinary skill in the art from a review of this disclosure. For example, one of ordinary skill in the art will appreciate that the steps discussed herein may be performed in other than the recited order, and that one or more steps may be optional in accordance with aspects of the invention.

What is claimed is:

1. An apparatus comprising:
a processor; and
a memory configured to store computer readable instructions that, when executed by the processor, cause the processor to perform a method comprising:
generating a digital map of damage to a damaged item;
based on the digital map and other information, generating a non-negotiable work order for repairing the damage to the damaged item; and
transmitting the non-negotiable work order to one or more repair shops.

2. The apparatus of claim 1, wherein the digital map is generated by a plurality of sensors.

3. The apparatus of claim 2, wherein the plurality of sensors include lasers and cameras.

4. The apparatus of claim 1, wherein the computer-readable instructions, when executed by the processor, cause the processor to further perform: transmitting the non-negotiable work order to a customer associated with the damaged item.

5. The apparatus of claim 1, wherein the damaged item comprises a vehicle.

6. The apparatus of claim 1, wherein the computer-readable instructions, when executed by the processor, cause the processor to further perform: receiving feedback related to an actual cost to repair the damage to the damaged item from the one or more repair shops.

7. The apparatus of claims 6, wherein the computer-readable instructions, when executed by the processor, cause the processor to further perform: using the feedback when generating future non-negotiable work orders for other damaged items.

8. The apparatus of claim 1, wherein the other information comprises telematics information from the damaged item.

9. The apparatus of claim 1, wherein the other information comprises information related to an actual cost to repair prior cases of damage to other damaged items.

10. The apparatus of claims 1, wherein the computer-readable instructions, when executed by the processor, cause the processor to further perform: transmitting an identification code to a customer associated with the damaged item to allow the customer to be identified at the one or more repair shops for work related to the non-negotiable work order to commence.

11. The apparatus of claim 1, wherein the computer-readable instructions, when executed by the processor, cause the processor to further perform: receiving at least one response from the one or more repair shops to indicate whether or not the one or more repair shops agree to terms of the non-negotiable work order.

12. The apparatus of claim 1, wherein the one or more repair shops are chosen based on proximity to a location of a customer associated with the damaged item.

13. A method comprising:
generating, at an enhanced claims settlement server, a digital map of damage to a damaged item;
based on the digital map and other information, generating, at the enhanced claims settlement server, a non-negotiable work order for repairing the damage to the damaged item; and
transmitting, from the enhanced claims settlement server, the non-negotiable work order to one or more repair shops.

14. The method of claim 13, further comprising: receiving, at the enhanced claims settlement server, feedback related to an actual cost to repair the damage to the damaged item from the one or more repair shops.

15. The method of claim 14, further comprising: using the feedback, at the enhanced claims settlement server, when generating future non-negotiable work orders for other damaged items.

16. The method of claim 13, further comprising: transmitting, from the enhanced claims settlement server, an identification code to a customer associated with the damaged item to allow the customer to be identified at the one or more repair shops for work related to the non-negotiable work order to commence.

17. The method of claim 13, further comprising: receiving, at the enhanced claims settlement server, at least one response from the one or more repair shops to indicate whether or not the one or more repair shops agree to terms of the non-negotiable work order.

18. A non-transitory computer-readable storage medium having computer-executable program instructions stored thereon that when executed by a processor, cause the processor at least to:
receive information related to damage to a damaged vehicle;
based on the received information, generate a non-negotiable work order for repairing the damage to the damaged vehicle;
transmit the non-negotiable work order to at least one repair shop; and
receive feedback as to an actual cost of repair from the at least one repair shop once the damage to the damaged vehicle has been fixed.

19. The non-transitory computer-readable storage medium of claim 18, wherein the received information comprises telematics data from the damaged vehicle.

20. The non-transitory computer-readable storage medium of claim 18, wherein the feedback is used to generate more accurate payment amounts associated with future work orders.
